(19) United States
(12) Patent Application Publication
(10) Pub. No.: US 2009/0220118 A1
(43) Pub. Date: Sep. 3, 2009

(54) Behind-the-head mounted personal audio set with adjustable earphone position

(75) Inventors: Thomas C. Meier, Woodbury, MN (US); Donald G. Varga, Portland, OR (US); Dominic Amae, Vancouver, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 11/914,068

(22) PCT Filed: Mar. 8, 2007
(86) PCT No.: PCT/US07/06050

§ 371 Date: Dec. 5, 2008

Related U.S. Application Data
(60) Provisional application No. 60/780,633, filed on Mar. 8, 2006.

(51) Int. Cl. H04R 25/00

(52) U.S. Cl. 381/379

(57) ABSTRACT

A behind-the-head mounted personal audio set that has a first earphone portion pivotally secured to a behind-the-head headband at a first pivot which is positioned below the longitudinal centerline of the headband. In disclosed embodiments the earphone is also slidably secured to the headband thereby allowing additional adjustment to optimize wearer comfort.

### CROSS-REFERENCE TO RELATED APPLICATIONS

This application is a continuation-in-part of U.S. patent application Ser. No. 11/357,933, filed on Feb. 16, 2006, and it claims priority to U.S. provisional patent application Ser. No. 60/653,712, filed on Feb. 16, 2005 and U.S. provisional patent application Ser. No. 60/780,633, filed on Mar. 8, 2006.

### FIELD OF THE INVENTION

The present invention relates to a behind-the-head mounted personal audio set with position adjustable ear-phones to allow the audio set to be adjusted as needed to optimize wearer comfort.

### BACKGROUND OF THE INVENTION

Personal audio-sets, commonly known as headphones, earphones, headsets, and the like, are gaining in popularity. The typical personal audio-set includes a frame containing an earphone that is usually positioned over or in a wearer's ear. In cases where the audio-set is a headset, a microphone is also typically positioned near the wearer's mouth.

One method for detachably securing a personal audio-set to a wearer includes securing the personal audio-set to a headband that encircles the rear portion of the wearer's head. These types of mounting structures are commonly known as “behind-the-head” mounts.

Known behind-the-head mounts have several drawbacks. For example, it can be difficult to adjust the position of the earphones relative to the headband to optimize wearer comfort.

### SUMMARY OF THE INVENTION

Accordingly, despite the available behind-the-head mounts for personal audio sets, there remains a need for a light weight, stylish, durable, and economical, mount that allows the position of the earphone to be adjusted by a user so as to optimize wearer comfort and the like. In addition to other benefits that will become apparent in the following disclosure, the present invention fulfills these needs.

The present invention is a behind-the-head mounted personal audio set that has a first earphone portion pivotally secured to a behind-the-head headband at a first pivot which is positioned below the longitudinal centerline of the headband. In disclosed embodiments the earphone is also slidably secured to the headband, thereby allowing additional adjustment to optimize wearer comfort.

The behind-the-head headband can also be segmented along its longitudinal centerline with the distal ends pivotally secured so as to substantially pivot about the longitudinal centerline of the headband.

### BRIEF DESCRIPTION OF THE DRAWINGS

FIG. 1 is a front, left, perspective view of a behind-the-head mounted personal audio set having individually pivoting headphones operably secured thereto and a boom microphone pivotally secured to one of the headphone assemblies showing a possible concealed position of the boom microphone in accordance with an embodiment of the present invention.

FIG. 2 is a right, perspective view of the of the behind-the-head mounted personal audio set of FIG. 1 showing a possible orientation of the boom microphone on the right side of the headset and a possible operational position of the boom microphone.

FIG. 3 is a rear, right, perspective view of the behind-the-head mounted personal audio set of FIG. 1 showing a possible orientation of the boom microphone on the right side of the headset with the boom microphone in the operational position.

FIG. 4 is a front, right perspective view of the behind-the-head mounted personal audio set of FIG. I in the configuration of FIG. 2 showing a possible mounting on a wearer shown in hidden lines.

FIG. 5 is a front, right, perspective view of the behind-the-head mounted personal audio set of FIG. 4 showing a possible position of one of the headphones so as to allow the personal audio set to operate in mono without covering one of the wearer's ears.

FIG. 6 is a right, perspective, partially exploded view of the behind-the-head mounted personal audio set of FIG. 2.

FIG. 7 is a front, left, perspective view of the behind-the-head mounted personal audio set of FIG. 1, showing a possible orientation with the boom microphone positioned on the wearer's right side.

FIG. 8 is a right side view of the behind-the-head mounted personal audio set of FIG. 1, in a second possible stereo configuration with the boom microphone positioned on the wearer's left side.

FIG. 9 is a right side view of the behind-the-head mounted personal audio set of FIG. 1, in a first possible mono configuration showing the earphone adjacent to the wearer's right ear pivoted so as to not cover the wearer's right ear.

FIG. 10 is a right side view of the behind-the-head mounted personal audio set of FIG. I with the earphone adjacent to the wearer's right ear pivoted so as to not cover the wearer's right ear, and with the boom microphone pivoted into an operational position adjacent to the wearer's mouth.

FIG. 11 is a right side view of the behind-the-head mounted personal audio set of FIG. 1 showing a possible orientation on a wearer's left ear.

FIG. 12 is a top, right, perspective view of the behind-the-head mounted personal audio set of FIG. 1, showing a possible pivoted position of the boom microphone.

FIG. 13 is a front, right, perspective view of the behind-the-head mounted personal audio set of FIG. 12.

FIG. 14 in an enlarged view of the boom microphone of FIG. 3 showing the possible operational position of the boom microphone.

FIG. 15 is an left, perspective view of the behind-the-head personal audio set of FIG. 1 showing the possible concealed position of the boom microphone of the left side.

FIG. 16 is a back, right, perspective view of the behind-the-head mounted personal audio set of FIG. 15 with the boom microphone positioned as shown in FIG. 14.

FIG. 17 us a top view of the behind-the-head mounted personal audio set of FIG. 1 with the boom microphone positioned on the left side and as shown in FIG. 14.

FIG. 18 is an enlarged top view of the left earphone of the behind-the-head mounted personal audio set of FIG. 1.

FIG. 19 is an enlarged rear view of the left earphone of FIG. 18.

FIG. 20 is a right, side view of the left earphone of FIG. 18.

FIG. 21 is a front, left perspective view of an alternative behind-the-head mounted personal audio set in accordance with an embodiment of the present invention.

FIG. 22 is a left side view of the alternative behind-the-head mounted personal audio set of FIG. 21 showing a possible orientation on a wearer, who is shown in broken lines.

FIG. 23 is a left, back isometric view of the alternative behind-the-head mounted personal audio set of FIG. 21.

FIG. 24 is a right side view of the alternative behind-the-head mounted personal audio set of FIG. 21.

FIG. 25 is a top view of the alternative behind-the-head mounted personal audio set of FIG. 21.

FIG. 26 is a bottom view of the alternative behind-the-head mounted personal audio set of FIG. 21.

FIG. 27 is an enlarged side view of an earphone component of the alternative behind-the-head mounted personal audio set of FIG. 21.

FIG. 28 is an enlarged exploded isometric view of the earphone component of FIG. 21.

FIG. 29 is an enlarged, exploded, isometric view of the behind-the-head headband of the alternative behind-the-head mounted personal audio set of FIG. 21.

FIG. 30 is a right, side view of the behind-the-head headband of FIG. 29 with a portion cut-away to show possible internal detail.

FIG. 31 is a top view of the behind-the-head headband of FIG. 29.

FIG. 32 is an enlarged, partial, isometric view of an alternative earphone and behind-the-head headband attachment structure in accordance with an embodiment of the present invention.

FIG. 33 is an exploded view of an alternative behind-the-head headband of FIG. 32.

FIG. 34 is an enlarged, partial view of a possible pivoting structure between the alternative earphone and behind-the-headband of FIG. 32.

### DETAILED DESCRIPTION OF PREFERRED EMBODIMENTS

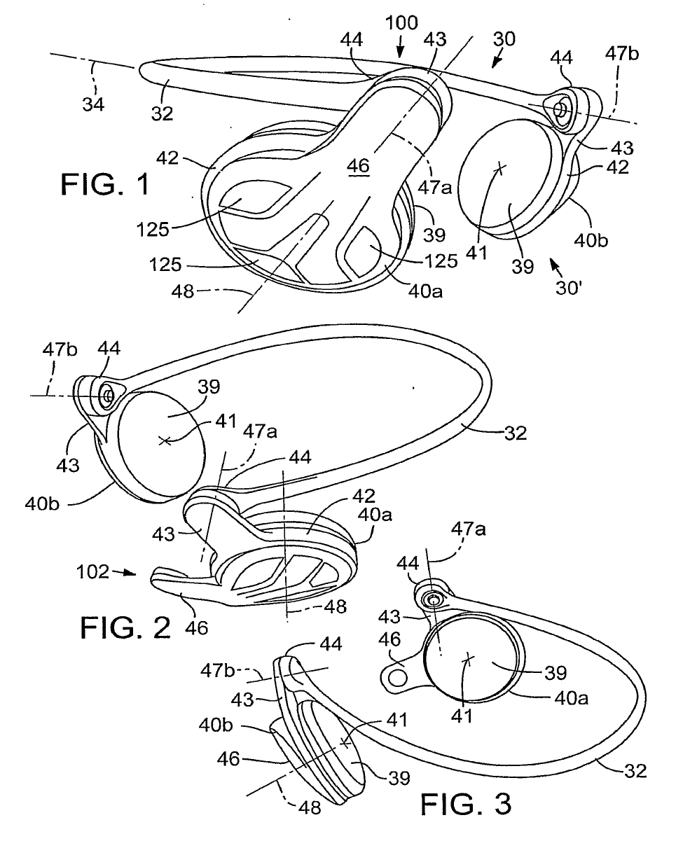

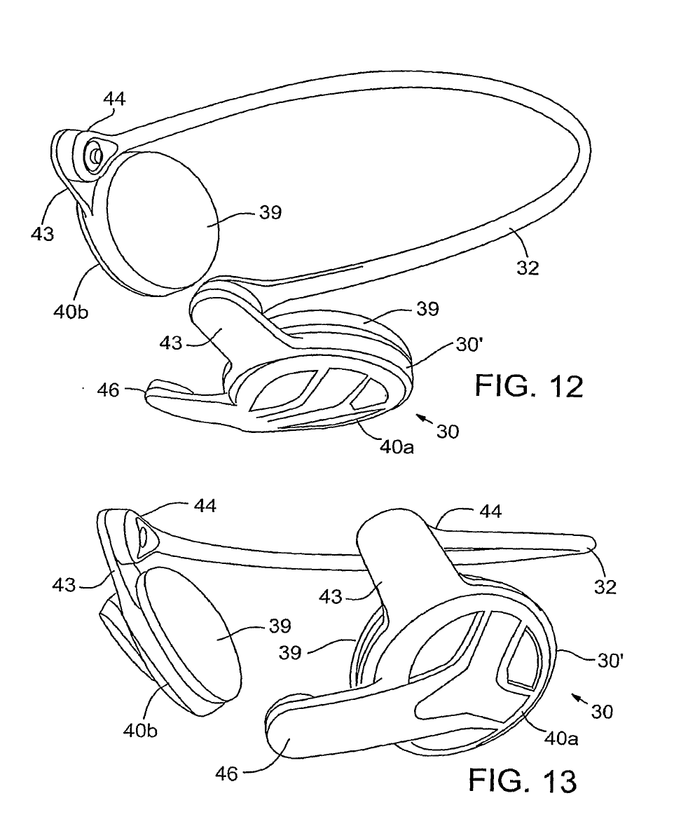

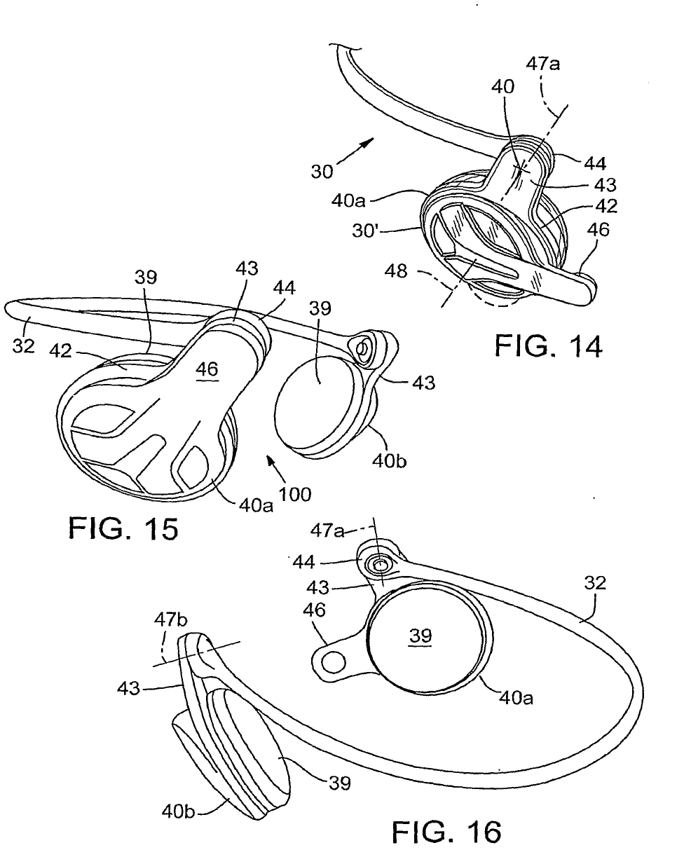

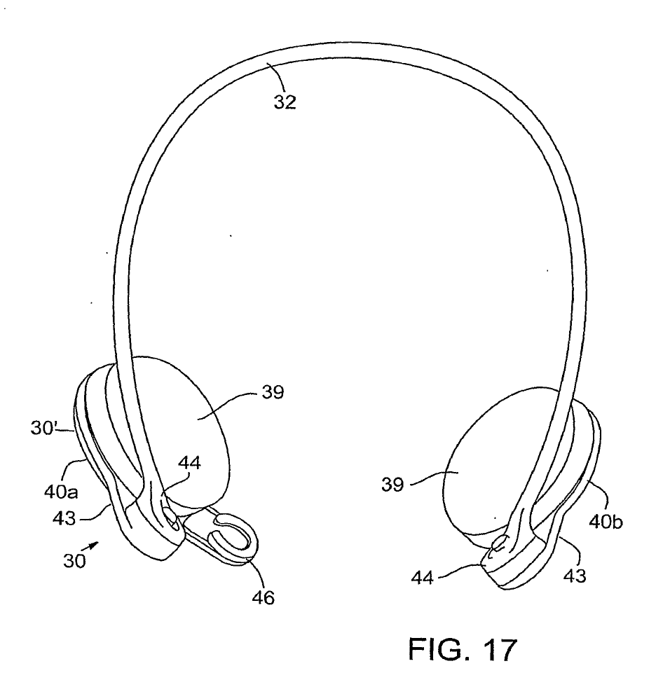

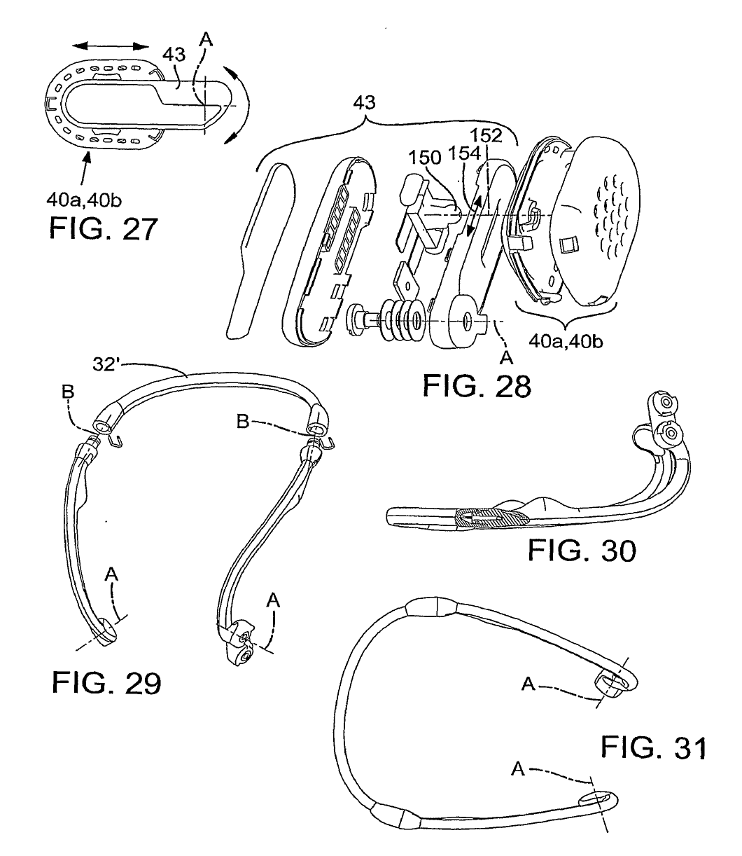

A behind-the-head mounted personal audio set 30 having two earphone portions 40a, 40b, each independently pivotally secured to a behind-the-head headband 32, is shown in FIGS. 1-34.

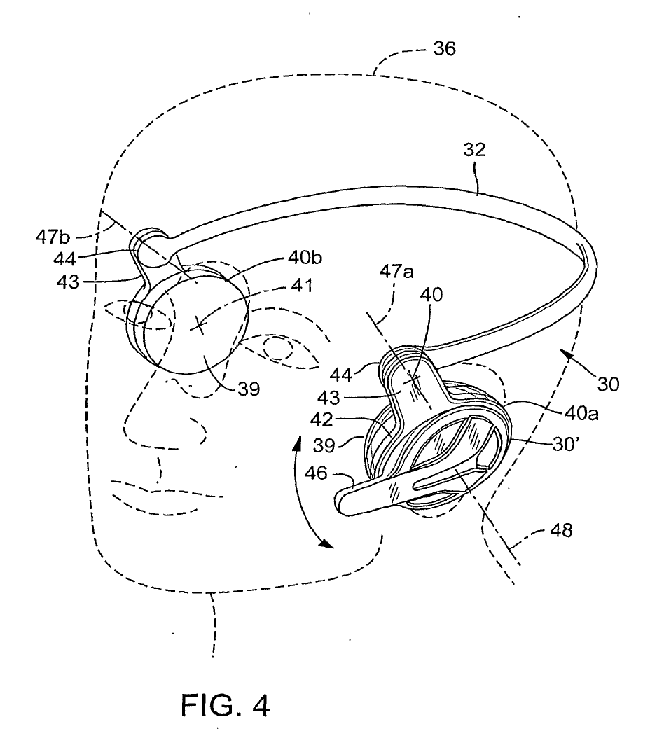

In a first preferred embodiment, shown in FIGS. 1-20, the behind-the head mounted personal audio set 30 has a curved headband 32, preferably occupying a common plane 34 as best shown in FIG. 1. As best shown in FIGS. 4, 5, and 7-11, the headband 32 is preferably sized to encircle and slightly grasp the rear contour of a wearer's head 36 substantially between the wearer's ears 38a, 38b. As shown in FIGS. 1-6, the earphone portions 40a, 40b are preferably positioned on opposite ends of the headband 32 at individual pivots 47a, 47b. Each pivot 47a, 47b operably secures an earphone-mounting portion 42 which as a substantially elongate pivot mounting portion 43 extending therefrom to operably engage the pivot, each earphone-mounting portion contains an earphone 39 therein. Preferably, the center 41 of each earphone 39 is positioned below the common plane 34 of the headband during stereo use of the personal audio set.

More preferably, the personal audio set 30 is a headset 30′ having a mini-boom microphone 46 extending therefrom. The mini-boom microphone 46 is preferably pivotally secured to the headset-mounting portion 42 at a defined third pivot 48. The length of the boom portion of the mini-boom microphone is preferably sized to define a concealed position 100 as best shown in FIGS. 1 & 15 when aligned with the substantially elongate pivot mounting portion 43. The mini-boom microphone may be pivoted about the third pivot 48 to define an operational position 102 of the mini-boom microphone as best shown in FIGS. 2-5, 7, 8, 12-14 and 16-20.

By pivoting the earphone mounting portions 42 about their respective pivots and the mini-boom microphone about the third pivot 48, the headset may be worn so that each earphone is positioned over one of the wearer's ears with the mini-boom microphone 46 positioned on either the wearer's left side as shown in FIGS. 4, 5 and 8, or a wearer's right side as shown in FIG. 7.

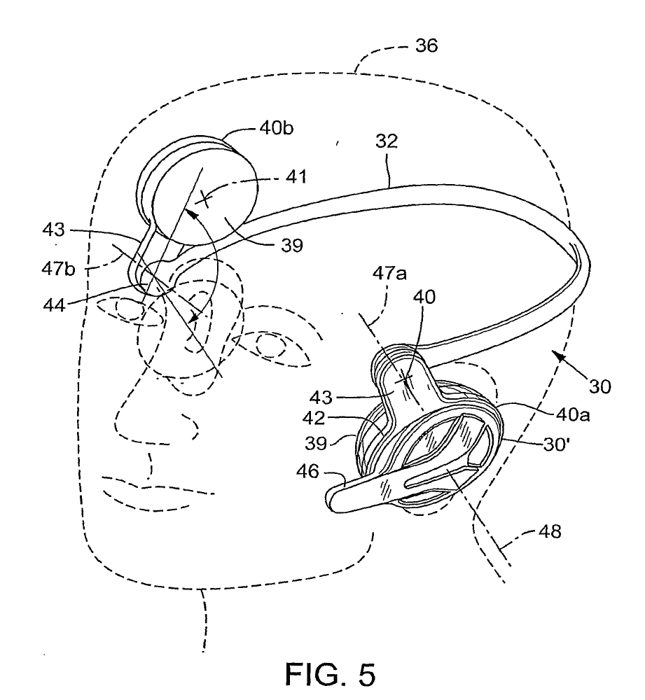

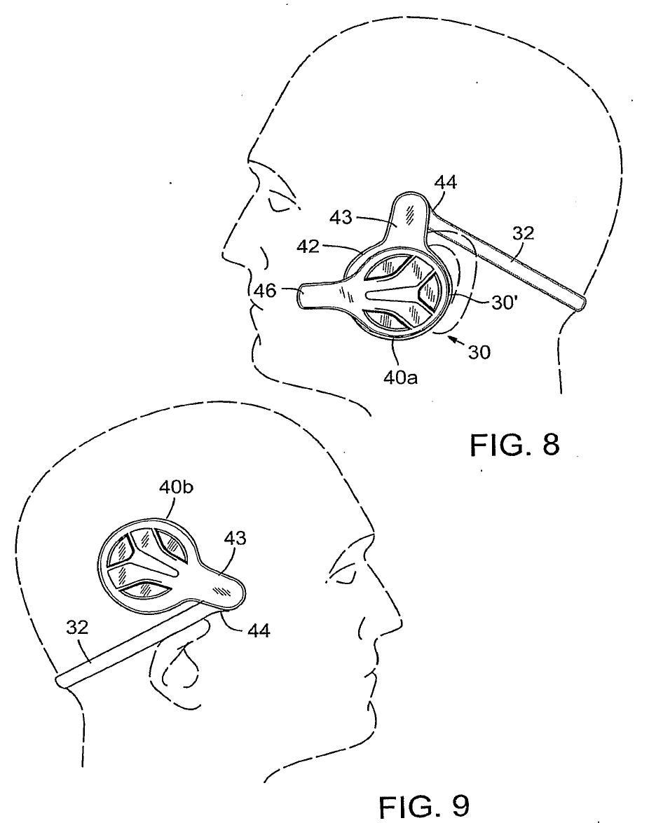

In addition, should the user desire or require using the personal audio-set in mono mode, and not have one of the earphone portions 40b cover an ear, as shown in FIG. 5, the user can pivot one of the earphone mounting portions 42 about its respective pivot 47b so that that earphone portion rests away from the respective ear. For example, one possible mono configuration is shown in FIGS. 8 and 9 shows one earphone portion 40a positioned over the wearer's right ear with the earphone mounting portion 42 containing the boom microphone 46 pivoted to its engaged position (FIG. 8) while the other earphone portion 40b is pivoted away from the wearer's left ear (FIG. 9). It can be appreciated that the disclosed structure can also be pivoted about its three pivots to provide the same basic configurations while covering the right ear with an earphone and preventing the left ear from being covered with an earphone.

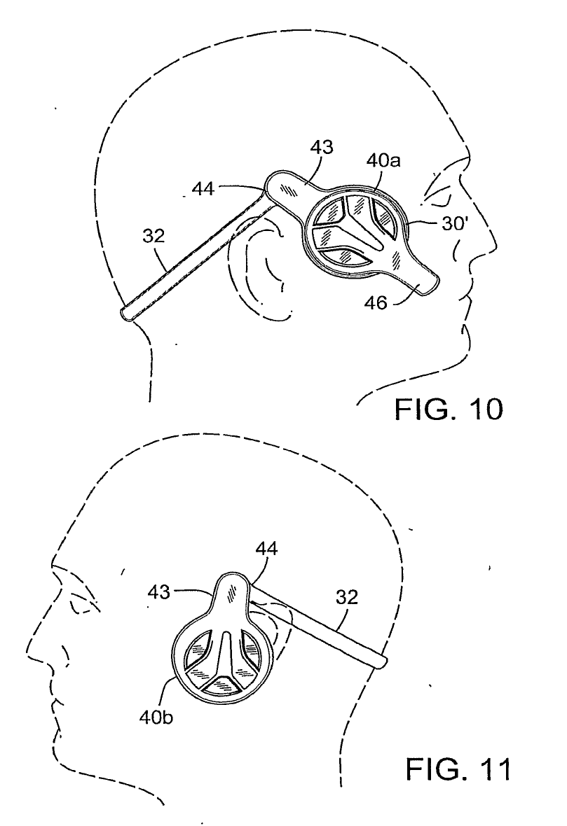

An alternative possible mono configuration is shown in FIGS. 10 and 11 with one earphone portion 40a moved forward of the wearer's left ear with the boom microphone 46 extending there from towards the wearer's mouth as shown in FIG. 10 and the opposite earphone portion 40b covering the wearer's right ear as shown in FIG. 11. It can be appreciated that the disclosed structure can also be pivoted about its three pivots to provide the same basic configurations while covering the left ear with an earphone and preventing the right ear from being covered with an earphone.

Preferably, the earphone portion 40a positioned nearest to the mini-boom microphone 46 is displaced from the wearer's ear during mono use as best shown in FIG. 10. However, the disclosed structure also allows a user to position the earphone furthest away from the mini-boom microphone away from the user's ear during mono use as shown in FIG. 5.

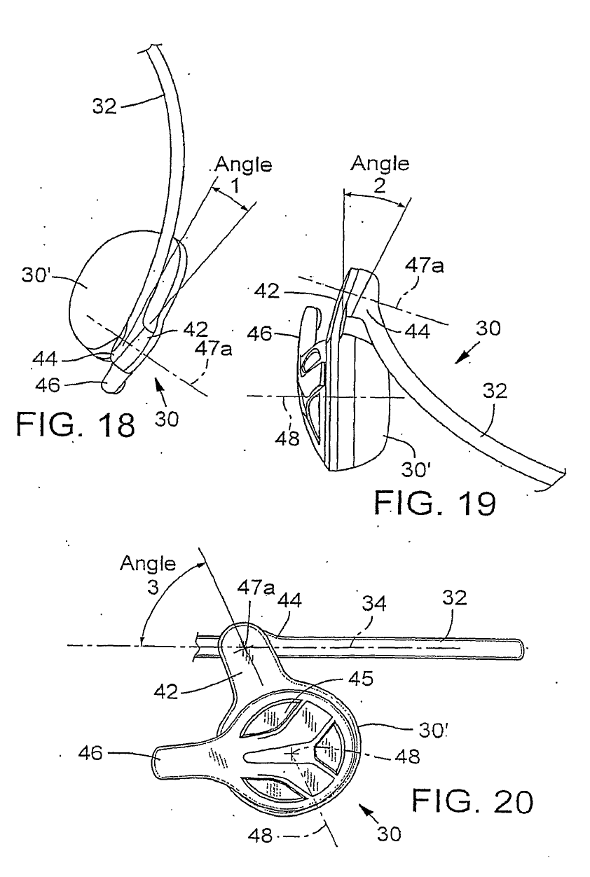

Preferably, the first and second pivots 47a, 47b are aligned along a defined three dimensional angle with respect to the headband 32 so as to optimize wearer comfort. This defined angle is shown as three two-dimensional angles in FIGS. 18-20 and labeled “angle 1” (FIG. 18), “angle 2” (FIG. 19), and “angle 3” (FIG. 20). Preferably, “angle 1”, which biases the position of the earphone portion of the audio set to fit the angle of a human ear when viewed from the top of the head is 12 degrees plus or minus 10 degrees. “Angle 2” (FIG. 19), which is the angle between the intersection of the first pivot 47a and the second pivot 48, is preferably 25 degrees plus or minus 20 degrees and “angle 3”, which is the angle between the common plane 34 of the headband 32 and the longitudinal centerline 45 of the headset mounting portion 42, is preferably about 60 degrees plus or minus 30 degrees. More preferably, “angle 3” is about 63 degrees.

More preferably, the first and second pivots 47a. 47b includes a detent mechanism 60 to allow proper alignment when the audio set 30 is positioned for wearing adjacent to either a wearer's left or right ears. Preferably, four detents are provided, one for the left ear position shown in FIG. 4, one for the right ear position shown in FIG. 7, one for the first desired mono position shown in FIG. 10, and one for the second desired mono position shown in FIG. 9.

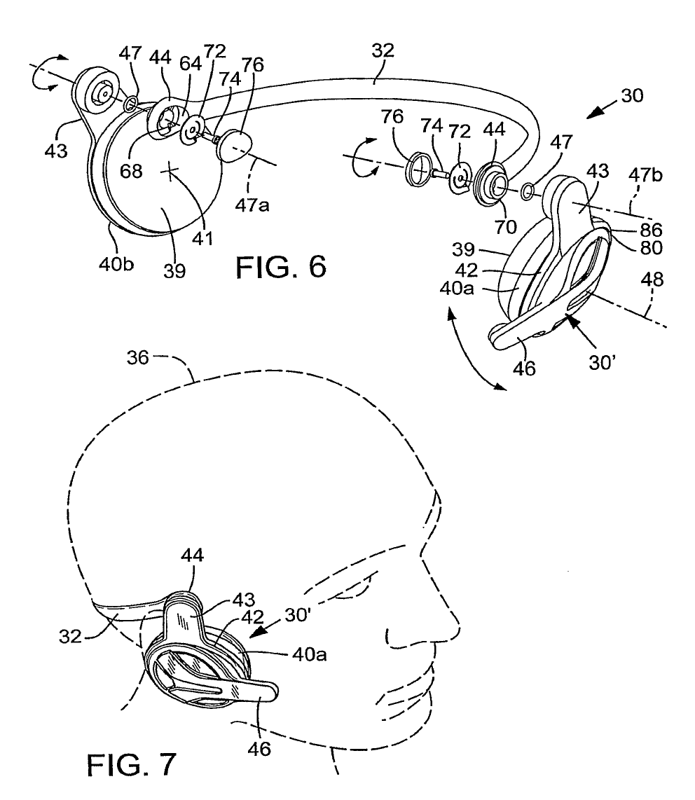

One possible pivot structure for the first and second pivot 47a, 47b is shown in FIG. 6. The opposite ends 44 of the headband 32 each include a recess 62 defining a cam surface 64. Recesses 66 are placed at defined positions along the cam surface 64 to define the detent positions. The headset mounting portion 42 includes a circular recess 68 sized to rotate about a circular protrusion 70 extending from the first end 44 of the headband 32. Preferably, a resilient o-ring 47 is positioned between the circular recess 68 and the circular protrusion 70 to create frictional holding force. A detent spring 72 is positioned within the recess 62 and secured to the headset mounting portion 42 with a fastener 74. Preferably the detent spring 72 is sized to engage the recesses 66 in the cam surface 64 thereby urging the headset mounting portion 42 to one of the defined detents. More preferably, a cover 76 covers the fastener 74 and detent spring 72.

A possible pivot structure for the third pivot 48 is shown in FIG. 6. The headset mounting portion 42 includes a substantially circular opening 80 about which the mini-boom microphone is pivotally secured thereto. The headset-mounting portion 42 preferably includes operating electronics therein. Preferably, an o-ring 86 is positioned within the circular opening 80 to hold a desired position of the mini-boom microphone. The personal audio set may be wired or wireless.

If desired, the electronics can contain suitable electronic control systems and control logic to deactivate the earphone not positioned adjacent to a wearer's ear during mono-use. This deactivation can be manually activated through a control button or the like positioned on the personal audio-set, or automatically detected by the control system based on predetermined criteria such as the position of the earphone mounting portions relative to the predetermined detents on the pivots. Alternatively, the control system can deactivate one earphone during use of the mini-boom microphone such as when a user is initially listening to music from one source, and then receives a phone call from another source.

Preferably, controls 125 in communication with the electronics, such as volume control, channel selection, on/off and the like are provided on an exterior surface of one of the earphone mounting portions. More preferably, these controls are positioned so as to allow them to be substantially at the same locations relative to the earphone mounting portion when that earphone mounting portion is worn on either the wearer's left or right ears. For example, the primary control is preferably a button positioned on the centerline of the earphone.

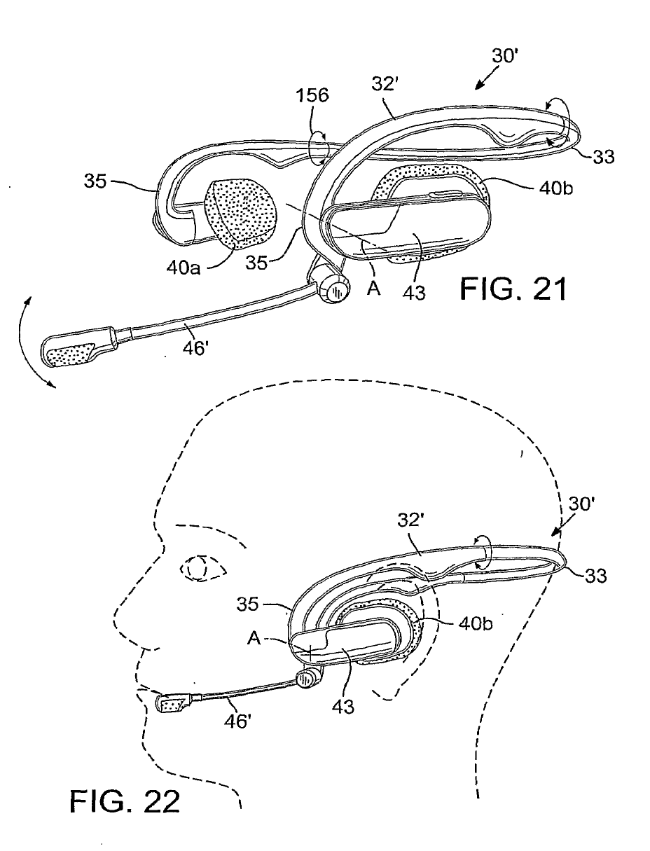

Referring to FIGS. 21-34, and alternative preferred behind-the-head personal audio set 30′ is disclosed. In order to reduce undue repetition, like elements between this embodiment and the previously described embodiment have like element numbers.

The headband 32′ of this embodiment preferably has an arcuate, substantially planar central portion 33 with downward curved distal ends 35 sized to extend over and down in front of the wearer's ears as best shown in FIG. 22.

Each earphone portion 40a, 40b is secured to a base portion 43 that is preferably pivotally secured toward the distal ends 35 of the headband 32′ to define a pivot A. Preferably, pivot A is positioned vertically below the wearer's ear canal. More preferably, each distal end 35 of the headband 32′ defines a pivot A, and both pivots A are aligned coincident with each other.

Preferably, an opposite engaging Belleville spring assembly 45 shown in FIG. 34 preferably operably holds the base portion 43 relative to the headband 32′ at each pivot A. Accordingly, each earphone portion 40a, 40b is infinitely positionable about its respective pivot A with the Belleville spring assembly operably holding each earphone at its selected position.

Each earphone portion 40a, 40b preferably includes an ear pad for engaging the wearer's ear. Alternatively, each earphone portion can include another form of acoustic delivery ear engaging structure such as a wedge or the like.

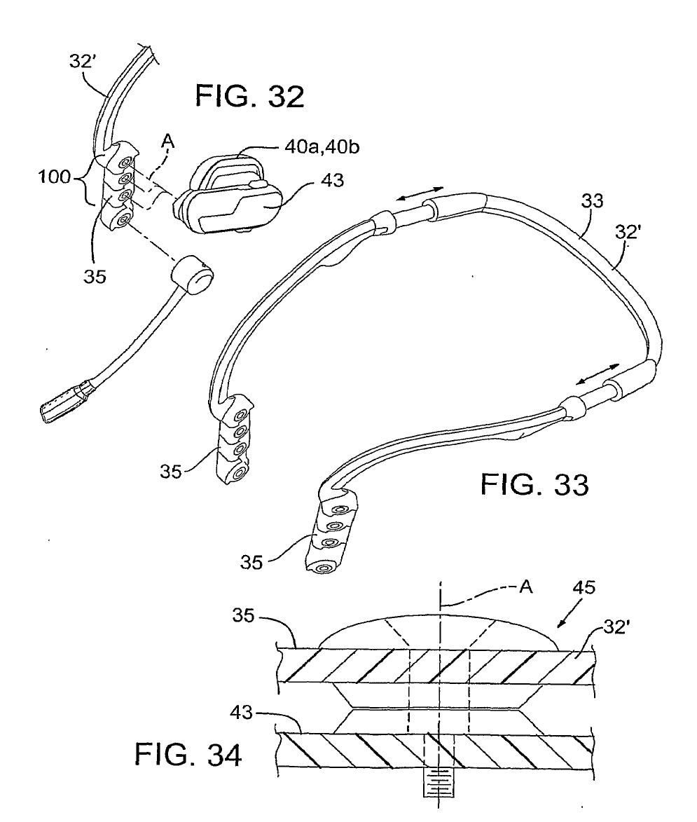

If desired, a plurality of spaced-apart, substantially vertically aligned pivot mounts 100 can be provided toward the distal ends 35 of the headband 32′ as best shown in FIGS. 32-33. Accordingly, a user can vertically adjust the location of pivot A as needed to optimize wearer comfort simply by changing the pivot mount into which the base 43 is attached.

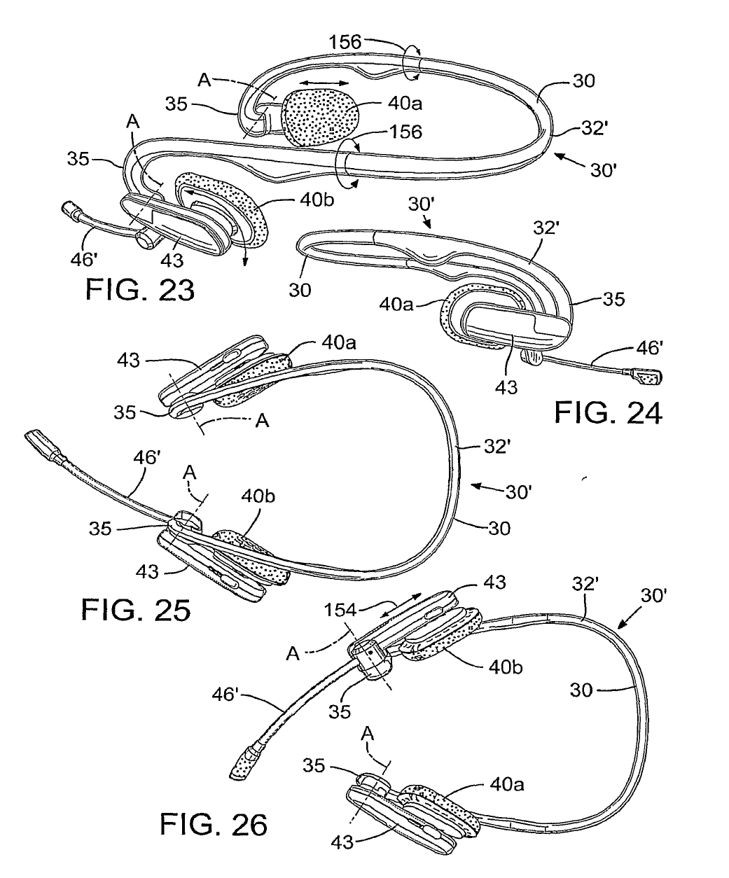

More Preferably and as best shown in FIGS. 23 & 26, each earphone portion 40a. 40b is also slidably secured to the base portion 43 so as to be slidable toward and away from pivot A as shown. One possible structure for sliding the earphone is shown in FIG. 28. Slider 150 protrudes through slot 152 to operably engage the earphone as shown and thereby allow the earphone to slide in the direction of arrows 154

More preferably, the distal ends 35 of the behind-the-head headband 32′ are pivotally secured to the base central portion 33 as shown in FIG. 21. Accordingly, the distal end portion may be pivoted as shown for storage.

Also, the distal ends 35 of the headband portion 32′ can be telescopically secured to the base central portion 33 as shown in FIG. 35, thereby making the headband substantially horizontally adjustable.

Referring to FIGS. 21, 23 and 29, the distal ends 35 of the behind-the-head headband 32′ is preferably pivotally secured to the base portion of the headband as shown to define pivots B that pivot substantially about the longitudinal centerline of the behind-the-head headband. More preferably, biasing members, such as coil springs or the like, are operably secured between the sections as shown to bias the distal ends in a neutral position.

If desired, a boom microphone 46′ can be pivotally secured toward the distal ends of the headband as shown. Preferably, the pivot for the boom microphone is spaced-apart from Pivot A.

Having described and illustrated the principles of our invention with reference to a preferred embodiment thereof, it will be apparent that the invention can be modified in arrangement and detail without departing from such principles. In view of the many possible embodiments to which the principles may be put, it should be recognized that the detailed embodiment is illustrative only and should not be taken as limiting the scope of our invention. Accordingly, we claim as our invention all such modifications as may come within the scope and spirit of the following claims and equivalents thereto.

I Claim:

1. A behind-the-head mounted personal audio set comprising:
a substantially elongate headband portion defining a longitudinal centerline, said headband portion curved to encircle the crown of the wearer's head;
a first earphone portion pivotally secured to the headband portion at a defined first pivot; and,
said first pivot operable to allow said first earphone portion to be operably positioned adjacent to one of either the wearer's left and right ears.

2. The behind-the-head mounted personal audio set of claim 1, further including:
a second earphone portion pivotally secured to the headband portion at a defined second pivot; and,
said second pivot operable to allow said second earphone portion to be operably positioned adjacent to other of the wearer's left and right ears.

3. The behind-the-head mounted personal audio set of claim 1, further including a boom microphone pivotally secured to said first earphone portion at a defined third pivot.

4. The behind-the-head mounted personal audio set of claim 3, wherein said first pivot and said third pivot are spaced apart from each other by a defined distance.

5. The behind-the-head mounted personal audio set of claim 1, further including an earphone base portion pivotally secured to said behind-the-head headband to define said first pivot, and said earphone is slidably secured to said earphone base portion.

6. The behind-the-head mounted personal audio set of claim 5, wherein said earphone is slidably secured to said earphone base to limit movement along a first sliding direction.

7. The behind-the-head mounted personal audio set of claim 6, wherein is said first sliding direction is toward and way from said first pivot.

8. The behind-the-head mounted personal audio set of claim 1, wherein said behind-the-head headband is arcuate and substantially planar to define a substantially longitudinal plane, and said earphone is positioned below said substantially longitudinal plane.

9. The behind-the-head mounted personal audio set of claim 6, wherein said behind-the head headband has a first distal end and a second distal end, each said first and second distal ends curve substantially downward below said substantially longitudinal plane.

10. The behind-the-head mounted personal audio set of claim 7, wherein said first pivot is operably positioned toward said one of said first and second distal ends.

11. The behind-the-head mounted personal audio set of claim 6, wherein said behind-the-head headband includes:
a curved base portion;
a first distal end pivotally secured to curbed base portion; and,
an opposite second distal end pivotally secured to said curved base portion.

12. The behind-the-head mounted personal audio set of claim 9, wherein said first and opposite second distal ends are pivotally secured to said curved base portion so as to pivot substantially about said longitudinal centerline.
